(19) United States
(12) Patent Application Publication
(10) Pub. No.: US 2026/0196775 A1
(43) Pub. Date: Jul. 9, 2026

(54) CONNECTION SYSTEM FOR GAUSSIAN CHAMBER TO GROUND AND ISOLATE ELECTRONIC SIGNALS

(71) Applicant: MITAS ELECTRONICS, LLC, Round Rock, TX (US)

(72) Inventors: Terrell J. Simpson, Round Rock, TX (US); Terrell Aram Simpson, Pflugerville, TX (US); David Michael Rich, Austin, TX (US); Xiaolong Zhang, Beijing (CN)

(21) Appl. No.: 19/443,876

(22) Filed: Jan. 8, 2026

Related U.S. Application Data
(60) Provisional application No. 63/743,338, filed on Jan. 9, 2025.

(51) Int. Cl. H01R 13/6581

(52) U.S. Cl. CPC H01R 13/6581

(57) ABSTRACT

A connection system for a Gaussian chamber to enhance 3-dimensional grounding and signal isolation in high-frequency electronic systems, and also asserts the use of Gauss chamber as a means to isolate signals within semiconductor devices to achieve significant levels of improvement in signal-to-noise ratio for signals exceeding 100 GHz. The system includes interlocking shield walls that seal the chamber, preventing signal leakage and ensuring a robust connection between a stationary receptacle, soldered to a Printed Circuit Board (PCB), and a plug, connected to a wire. A conductive gasket at the PCB level and a multi-layer board strategy using copper layers and vias ensure continued isolation through the PCB, preventing crosstalk and improving signal integrity. The 3-dimensional grounding surrounds the signal path with copper, effectively capturing electric field energy to reduce interference between differential pairs. The system is backward compatible with existing industry standards, allowing seamless integration into current systems.

### CROSS-REFERENCE TO RELATED APPLICATIONS

The present application claims benefit of Provisional Application No. 63/743,338, filed Jan. 9, 2025; all which are incorporated herein in their entirety and referenced thereto.

### BACKGROUND OF THE INVENTION

### Field of the Invention

The present invention relates to electromagnetic shielding and grounding in electronic systems, and in particular, relates to a connection system for gaussian chamber to ground and isolate electronic signals especially in environments where signal integrity and isolation are crucial, such as in radio frequency (RF) circuits, high-speed digital circuits, nano-scaled semiconductor circuits, or sensitive measurement systems.

### Description of the Prior Art

In electronic systems, particularly those dealing with high-frequency signals, maintaining signal integrity and minimizing electromagnetic interference (EMI) are critical challenges. As electronic devices become more complex and the demands for higher data rates and faster signal processing increase, ensuring that signals are not degraded or lost during transmission becomes increasingly difficult. One of the primary issues arises from crosstalk, where signals from adjacent lines interfere with each other, leading to data errors, reduced performance, and even system malfunctions.

Traditional grounding and shielding techniques often employ 2-dimensional solutions, such as placing a coplanar ground pad between differential signal pairs to absorb the electromagnetic field energy emitted from adjacent signals. While these methods have been effective for lower-frequency signals and simpler systems, they fall short when faced with increasingly smaller form factors (high density interconnects) delivering high-frequency signals. As frequencies increase, electromagnetic fields become more powerful, and traditional field absorbing strategies are no longer sufficient to capture and redirect the electric field energy effectively, leading to signal leakage and interference.

Additionally, inadequate grounding exacerbates these problems. Signals that are not properly grounded can introduce noise, cause signal reflection, and further disrupt the performance of the system. In some cases, grounding strategies are limited by the design of the printed circuit board (PCB), where multiple layers and densely packed components increase the likelihood of signals leaking into adjacent layers or components, causing interference across different sections of the board. Moreover, systems utilizing differential pairs i.e. pairs of conductors that carry equal and opposite signals to improve noise rejection are especially vulnerable to these issues. When traditional 2D shielding methods fail to fully surround the signal paths, crosstalk between differential pairs becomes a major problem, degrading the signal quality and impacting the overall reliability of the system. This challenge is particularly pressing in applications such as high-frequency communication, data transmission, and sensitive electronic environments where signal precision and integrity are paramount.

Given the increasing complexity of modern electronic systems, the limitations of existing grounding and shielding techniques have become more pronounced. As a result, there is a requirement for a more comprehensive and robust solution that can provide better isolation, prevent crosstalk, and maintain signal integrity even in 3-dimensional structures. Such a solution would need to accommodate the high-frequency demands of contemporary systems, while being compatible with existing designs to ensure seamless integration without substantial redesign.

The information disclosed in this background of the disclosure section is only for enhancement of understanding of the general background of the disclosure and should not be taken as an acknowledgment or any form of suggestion that this information forms existing information already known to a person skilled in the art.

### SUMMARY OF THE INVENTION

The present disclosure is a connection system for Gaussian chamber that enhances 3-dimensional grounding and signal isolation in high-frequency electronic systems, particularly where signal integrity and electromagnetic interference (EMI) protection are crucial. The system isolates each signal within the chamber to prevent crosstalk and maintain high performance, allowing for faster data transmission over longer distances without signal degradation. The present disclosure is not intended to be all inclusive to the exclusion of other intended means and methods, and fully intends to extend to additional means and methods relevant to nano-scaled semiconductor devices.

In an embodiment, the connection system includes three primary components: 1) a plug that terminates the wire, 2) a receptacle that is soldered to a Printed Circuit Board (PCB), and 3) the PCB. The primary components include interlocking shield walls that seal the chamber and ensure secure access while preventing signal leakage. The plug and receptacle interlock through grooves and flat surfaces, maintaining a strong mechanical connection and a good seal. Other nano-scale means and methods such as interlocking layers, nano-constructed chambers are intended and easily scalable utilizing photolithography or other atomic layer deposition means and methods.

In an embodiment, a mechanical connection such as a conductive gasket or embossed feature is employed at the board level to prevent signal leakage at the junction between the connector and the PCB. Further, the mechanical connection reinforces the integrity of the system by keeping the receptacle in place during plug insertion and removal. In an embodiment, isolation inside the PCB is achieved through a combination of fencing (likely physical barriers on the PCB) and a multi-layer board strategy, using copper layers separated by an dielectric material. The copper layers form the top and bottom of the Gaussian chamber, connected by vias, and act as copper tubes embedded in the PCB to connect the layers. The spacing of the vias is precisely tuned to match the operating frequencies, creating a solid copper wall that maintains signal isolation.

In an embodiment, the 3-dimensional grounding of the system surrounds the signal path with copper to capture more electric field energy and prevent adjacent differential pairs from interfering with each other: it is understood that materials such as Carbon Nanotubes as well as other conductive semiconductor materials would apply for nano-scaled means and methods. Further, the 3-dimensional grounding approach reduces crosstalk and ensures that even at high frequencies the signal remains stable.

In an embodiment, backward compatibility of the system with existing industry standards makes the system integrable into current electronic systems without requiring significant changes. Further, the connection system for the Gaussian chamber provides a reliable, high-performance solution for maintaining signal integrity and reducing EMI in demanding electronic applications.

It is noted that the application of three dimensional grounding and signal isolation is not limited to the mechanical means, methods and materials previously described and servers only one application of the method for improving signal transmission. Moreover, further methods and applications are intended as a means for electromagnetic isolation in nano-scaled semiconductor devices comprising construction of Gaussian chambers around differential signal pairs to minimize crosstalk and EMI.

With careful selection of thermally conductive yet electrically insulating materials using Gaussian chambers can reduce thermal noise by isolating differential pairs. Such means and methods is particularly useful in cutting edge semiconductor fields like photonic circuits, or in quantum computing to maintain qubit coherence by minimizing electromagnetic interference.

Beyond the illustrated summary of invention, this disclosure intends to claim application relevance when fabricating a signal-isolating Gauss chamber in a semiconductor device: forming isolating chamber walls using atomic layer deposition.

The charts below are results of simulations of the present disclosure using CST Microwave, and corroborated by HFSS as well as COMSOL.

The features and advantages of the subject matter hereof will become more apparent considering the following detailed description of selected embodiments, as illustrated in the accompanying FIGUREs. As one of ordinary skill in the art will realize, the subject matter disclosed herein is capable of modifications in various respects, all without departing from the scope of the subject matter. Accordingly, the drawings and the description are to be regarded as illustrative

### BRIEF DESCRIPTION OF THE DRAWINGS

The present subject matter will now be described in detail with reference to the drawings, which are provided as illustrative examples of the subject matter to enable those skilled in the art to practice the subject matter. It will be noted that throughout the appended drawings, features are identified by like reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 is a connection system for a gaussian chamber, in accordance with an embodiment of the present disclosure.

FIG. 2A-2C are various views of the gaussian chamber, in accordance with an embodiment of the present disclosure.

FIG. 3A-3B are various views of receptacle feet shown inside a receptacle side of the gaussian chamber, in accordance with an embodiment of the present disclosure.

FIGS. 4A-4C are existing systems having receptacle feet outside the receptacle. There is one system with all feet inside the shield cover, however, there is no isolation between signals. This can be represented by removing the exposed SMT feet of FIG. 4B marked as 402.

FIGS. 5A-5D are 3-dimensional grounding that fully contains the differential pair and isolates from adjacent differential pairs, in accordance with an embodiment of the present disclosure.

FIGS. 6A-6D are various supplemental views of the interlocking gaussian chamber walls, in accordance with an embodiment of the present disclosure.

FIG. 7 is a printed circuit board (PCB) level chamber isolation vias, in accordance with an embodiment of the present disclosure.

FIG. 8 is a cutaway of PCB showing continued chamber isolation, in accordance with an embodiment of the present disclosure.

FIGS. 9A-9E are various connector system designs, in accordance with an embodiment of the present disclosure.

### DETAILED DESCRIPTION OF THE PREFERRED EMBODIMENT

The detailed description set forth below in connection with the appended drawings is intended as a description of exemplary embodiments in which the presently disclosed disclosure can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed disclosure. However, it will be apparent to those skilled in the art that the presently disclosed disclosure may be practiced without these specific details. In some instances, well-known structures and devices are shown in block diagram form in order to avoid obscuring the concepts of the presently disclosed disclosure.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection. Based on the disclosure provided herein, one of ordinary skill in the art will appreciate a variety of ways in which connection or coupling exists in accordance with the definition.

Further, the term “module” may be software or hardware particularly programmed to receive an input, perform one or more processes using the input, and provide an output. The input, output, and processes performed by various modules will be apparent to one skilled in the art based on the present disclosure.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular name.

The present disclosure is a connection system for a Gaussian chamber that enhances 3-dimensional grounding and signal isolation in high-frequency electronic systems, particularly where signal integrity and electromagnetic interference (EMI) protection are crucial. The system isolates each signal within the chamber to prevent crosstalk and maintain high performance, allowing for faster data transmission over longer distances without signal degradation. The connection system includes three primary components: 1) a plug that terminates the wire, 2) a receptacle that is soldered to a Printed Circuit Board (PCB), and 3) the PCB. The primary components include interlocking shield walls that completely seal the chamber and ensure secure access while preventing signal leakage. The plug and receptacle interlock through grooves and flat surfaces, maintaining a strong mechanical connection and a good seal.

At the board level, a mechanical connection such as a conductive gasket or embossed feature is employed to prevent signal leakage at the junction between the connector and the PCB. Further, the mechanical connection reinforces the integrity of the system by keeping the receptacle in place during plug insertion and removal. Inside the PCB, isolation is achieved through a combination of fencing (likely physical barriers on the PCB) and a multi-layer board strategy, using copper layers separated by an dielectric material like FR4. The copper layers form the top and bottom of the Gaussian chamber, connected by vias, which act as copper tubes embedded in the PCB to connect the layers. The spacing of the vias is precisely tuned to match the operating frequencies, creating an electrically effective solid copper wall that maintains signal isolation. The 3-dimensional grounding of the system surrounds the signal path with copper, to capture more electric field energy and prevent adjacent differential pairs from interfering with each other. Further, the 3-dimensional grounding approach reduces crosstalk and ensures the signal remains stable, even at high frequencies.

Moreover, backward compatibility of the system makes the system integrable into current electronic systems without requiring significant changes. Further, the system provides a reliable, high-performance solution for maintaining signal integrity and reducing EMI in demanding electronic applications.

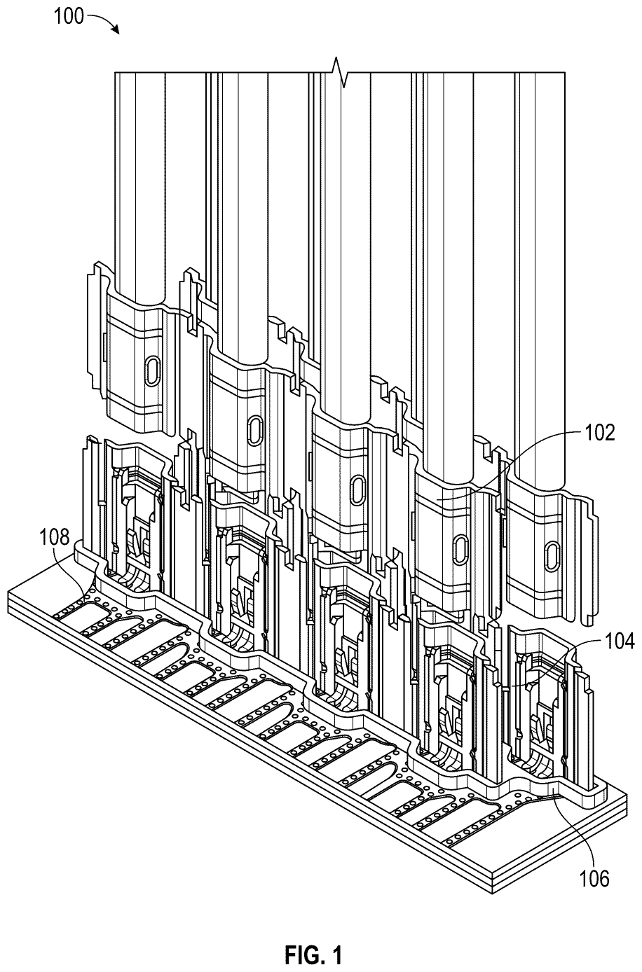

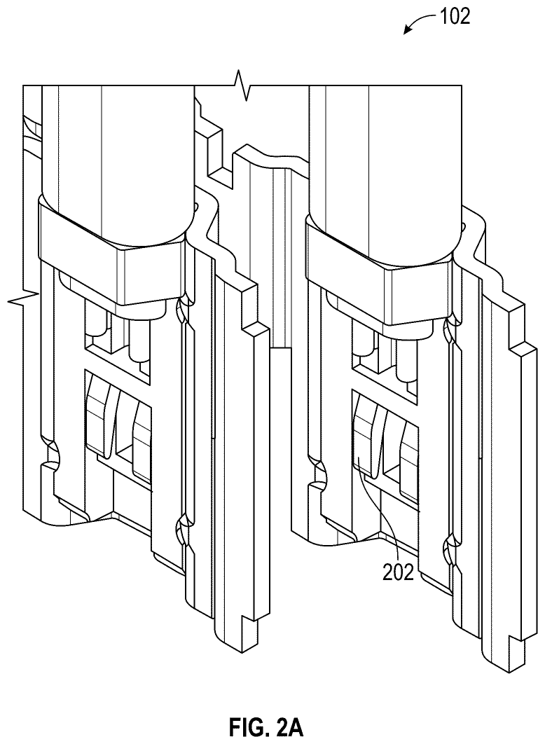

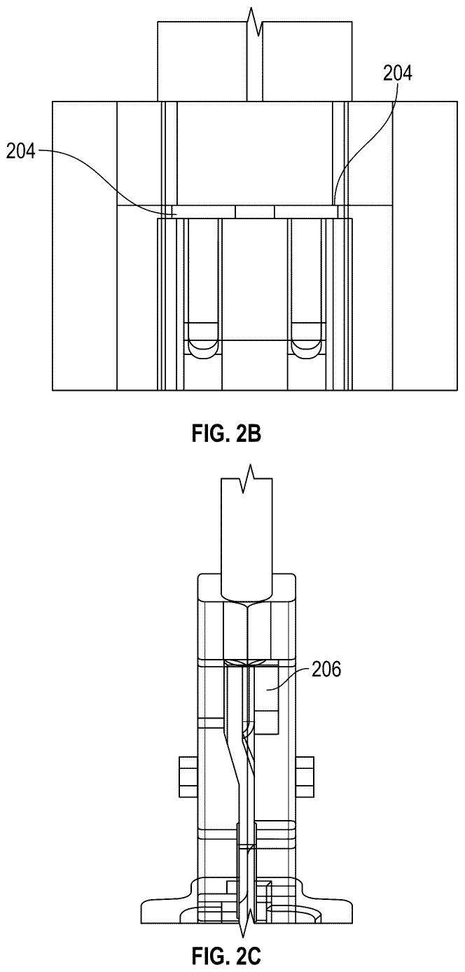

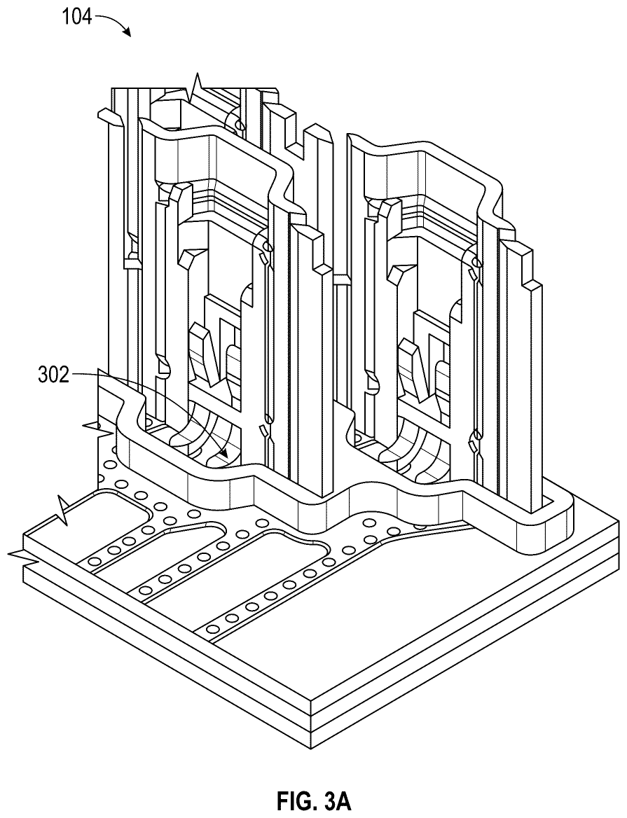

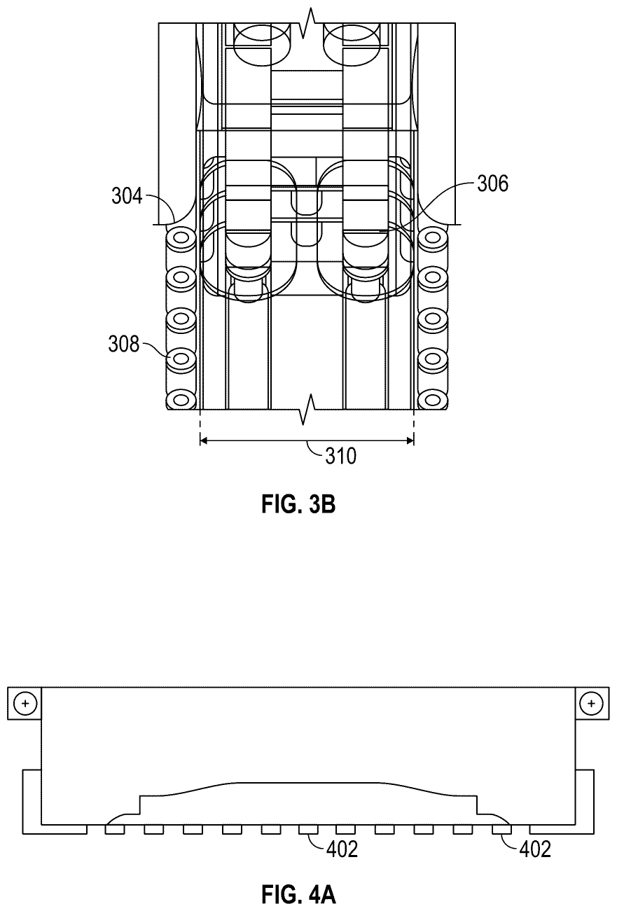

FIG. 1 is a connection system 100 for a gaussian chamber 102, in accordance with an embodiment of the present disclosure. FIG. 2A-2C are various views of the gaussian chamber 102, in accordance with an embodiment of the present disclosure. FIG. 3A-3B are various views of receptacle 104 shown inside a receptacle side of the gaussian chamber 102, in accordance with an embodiment of the present disclosure. For the sake of brevity, FIGS. 1, 2A-2C and 3A-3B have been explained together.

In an embodiment, the gaussian chamber 102 may include 2 interlocking shield walls 104 (also termed as receptacle 104), a conductive gasket 106, and a printed circuit board (PCB) 108. Further, the gaussian chamber 102 may contain a single or multiple signals and may isolate the signal(s) from adjacent chambers. Such isolation may be performed by the 2 interlocking shield walls 104 that may completely seal the gaussian chamber 102 and provide 3-dimensional grounding. Further, the conductive gasket 106 (may also be termed as “embossed feature”) at the board level may prevent leakage between a connector, receptacle, and the PCB 108. In an embodiment, the gaussian chamber 102 isolation in the PCB 108 may be achieved via fencing and a multi-layer board strategy that may continue the waveguide from the wire to the signal's destination. Further, as shown in FIG. 2A, the gaussian chamber 102 may be split into two halves that may allow for the connector to be plugged and unplugged from the receptacle 104 to allow for assembly. Such plugging and unplugging may be significant because access to the inside of the gaussian chamber 102 may be necessary for everything from soldering the wires to the connector to disconnecting the wire from the PCB 108 in order to route the wire and assemble the product that such connector is powering. Additionally, as shown in FIG. 2B-2C, the signal transition may be performed from wire to contact to mitigate reflection and impedance tune with dielectric constant (DK) plastic through a robust connection between the shield layer of the wire and the gaussian chamber wall. The gaussian chamber wall may provide solid electrical isolation and a strong mechanical joint. Further, the gaussian chamber wall may surround the differential signal pad and isolate it from adjacent differential signal pairs. Since short wire dielectric length between shield layer of wire and connector contact, as shown by 204, reduces variances in connector cross-section which degrades performance, the wire and contacts are centered throughout the chamber, as shown by 206, to improve performance. Further, as shown by 206, the ratio of plastic to air around the contacts is changed to allow the impedance to be tuned for the application.

In an embodiment, as shown in FIG. 3A, the receptacle 104 and the end of the contact that may get soldered to the contact on the PCB 108 may connect the plug and receptacle to the circuitry in the PCB 108. It may be apparent to a person skilled in the art that the existing solutions have covers to isolate the mated contacts from the outside world but still rely on the ground between adjacent differential pairs to minimize the crosstalk to each other, as discussed in the following paragraphs. In contrast, the connection system 100 includes the receptacle 104 inside the gaussian chamber 102 to isolate the signal from the outside world and also isolate the signal from adjacent differential pairs. Such an arrangement facilitates keeping all the electric field energy related to one set of signal pairs inside one gaussian chamber 102 so that nothing gets out and talks to an adjacent signal pair resulting in complete isolation of the signals.

Further, as shown in FIG. 3B, reflection and resonance may be mitigated using low Dk plastic inserts and smooth geometrical features, allowing transitions over ¼ wavelength minimum. In an embodiment, the chamber wall may transition via fence, as shown by 308, to continue differential signal pair isolation from adjacent differential pair signals. Further, a consistent cross-section may be maintained in chamber size, such that misalignment between the chamber wall in the connector and the via fence in the PCB, as shown by 304, may provide the opportunity for a mode change that may negatively impact performance. Furthermore, consistent signal trace cross-section may be maintained, such that consistent signal trace cross-section, width, pitch, thickness, and dielectric material all work together to maintain proper impedance, as shown by 306. Additionally, waveguide broad wall dimensions, as shown by 310, may be kept constant to maintain a high cut-off frequency.

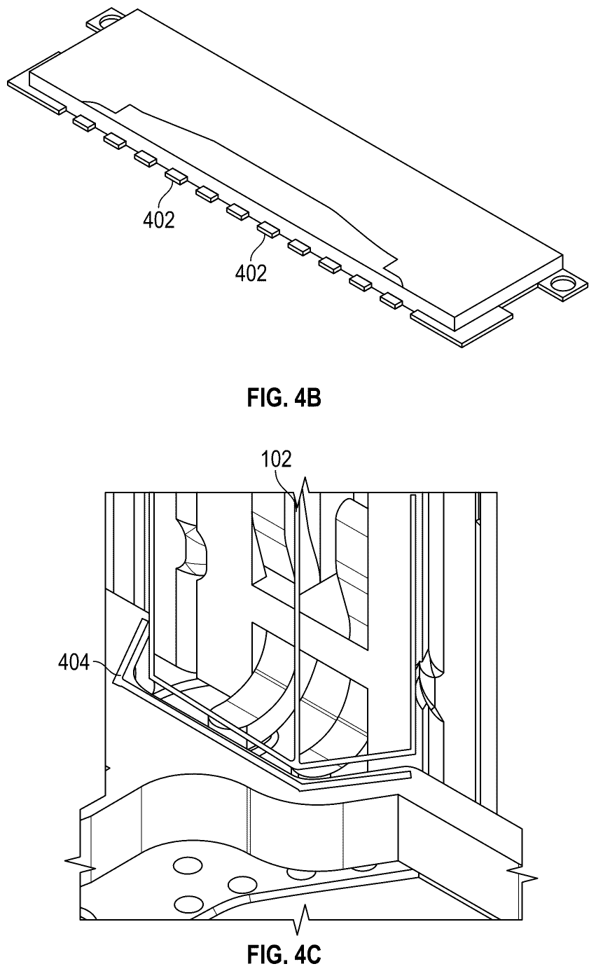

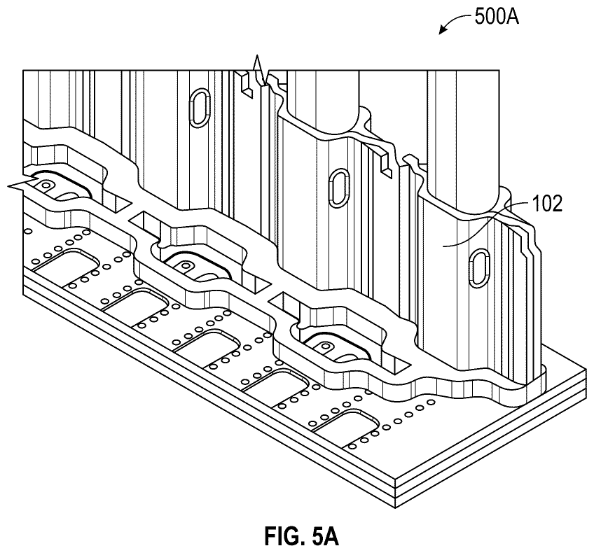

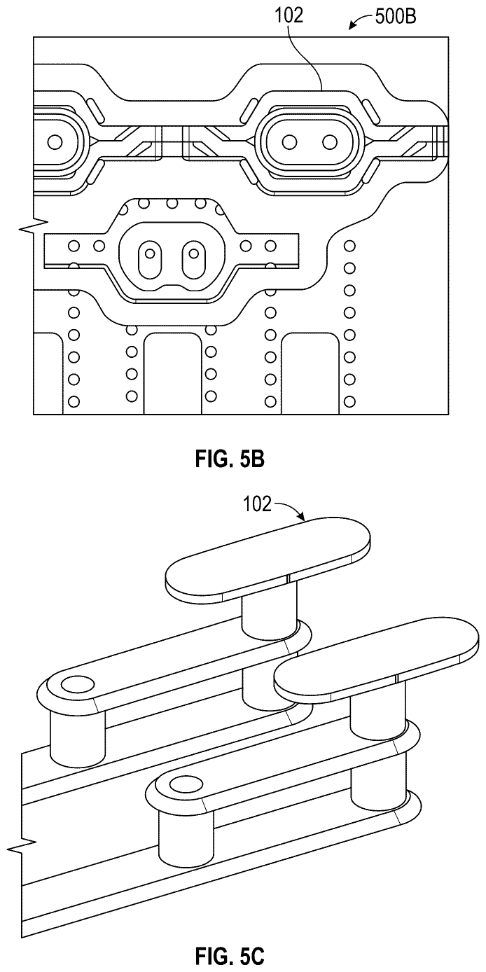

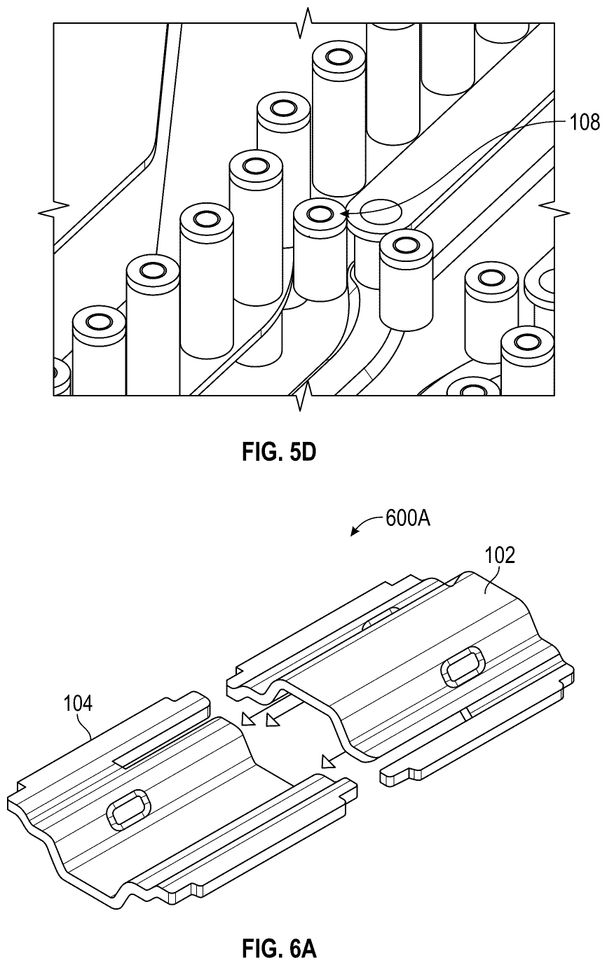

FIGS. 4A-4B are existing systems having receptacle feet outside the receptacle. FIGS. 5A-5D are 3-dimensional grounding that fully contains the differential pair and isolates signals from adjacent differential pairs, in accordance with an embodiment of the present disclosure. For the sake of brevity, FIGS. 4A-4C and 5A-5D have been explained together. As illustrated in FIGS. 4A and 4B, the existing system may have the receptacle feet on the outside of the receptacle with only ground to isolate the differential pairs from each other. Such receptacle feet are shown by way of exposed copper contacts 402 on the outside of the system, such exposed copper contacts 402 are soldered to the PCB 108. Moreover, in the system wherein the feet are inside the cover there is no mitigation of inter-pair noise effects. Further, as illustrated in FIG. 4C, such connector plugs have a conductive gasket as shown by 404, and a plug half of the gaussian chamber 402 and have covers to isolate the receptacle feet from the outside world but still rely on the ground between adjacent differential pairs to minimize the crosstalk to each other. The crosstalk may lead the system to radiate energy to the surroundings and also affect the efficiency of the system in isolating the signals.

In an embodiment, as shown in FIGS. 5A and 5B, the connection system 100 of the present disclosure facilitates the 3-dimensional grounding 500A and 500B of the gaussian chamber 102 by fully containing the differential pairs. It may be apparent to a person skilled in the art that the illustration in FIGS. 5A and 5B are merely exemplary with differential pairs but could be single or multi-conductors depending on the application, without departing from the scope of the disclosure. Thus, the 3-dimensional grounding fully surrounds the signal path from the wire through the PCB 108 to the signal destination which starts with the plug side gaussian chamber wall which gets soldered to the shield layer on the wire, continues through the connector in the gaussian chamber shield walls (plug and receptacle sides), to the top of the PCB 108 where the conductive gasket/embossed feature ensures that there are no gaps between the bottom of the connector and the top of the PCB 108 and finally into the PCB 108 with multiple copper layers insulated by dielectric material and connected by vias to capture all of the electric field energy from one differential pair and keep the energy contained within the gaussian chamber 102 to prevent the energy from talking to adjacent differential pairs. To maintain high cut-off frequency, via fence cross-section may be maintained and the via fence may continue the isolation of adjacent differential signal pair. Further, to reduce power flux density at sharp right angle turns, 2-step via step down may be used strategically, as shown in FIG. 5C, which may smooth the sharp turns created in the PCB at the joint between the vias and trace. Furthermore, as shown in FIG. 5D, critical areas/features that could cause high reflection or attenuation may be stitched to mitigate potential loss.

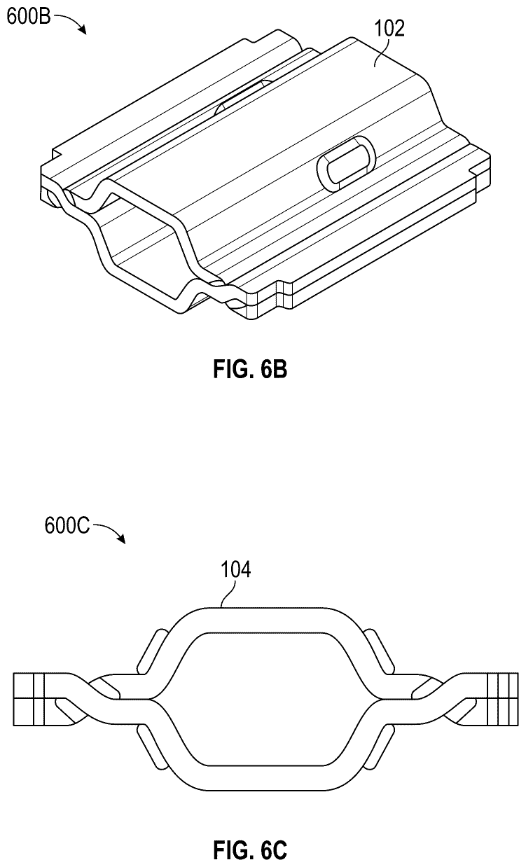

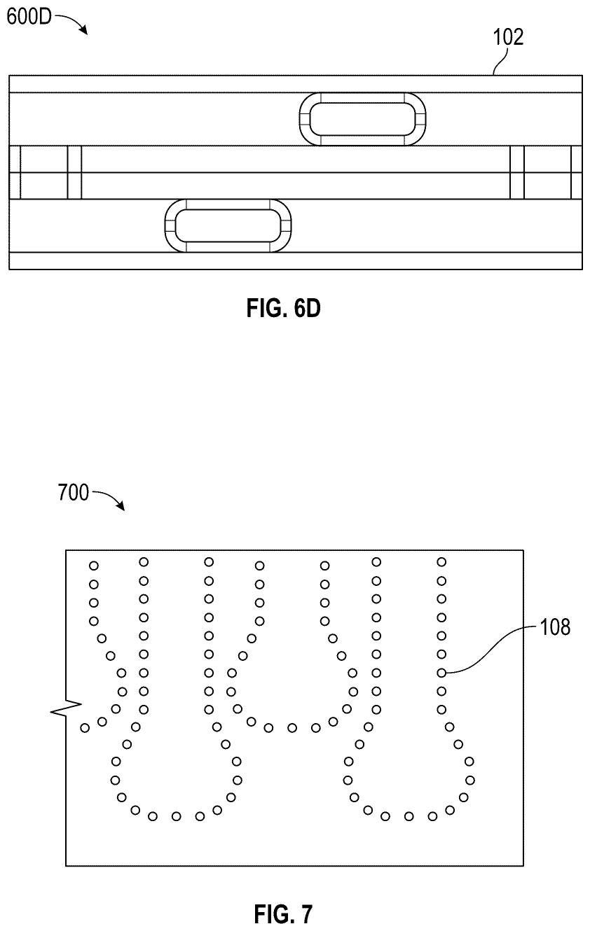

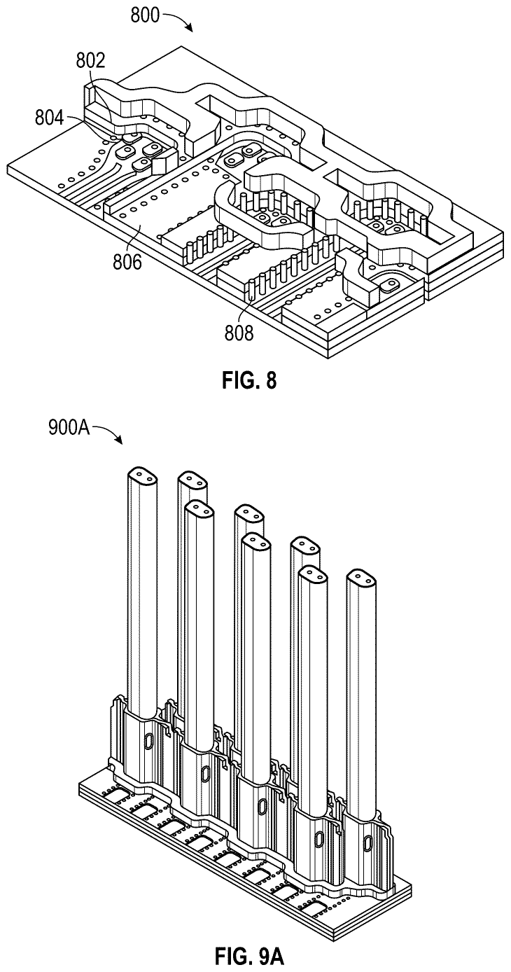

FIGS. 6A-6D are various supplemental views 600A-600D of the interlocking gaussian chamber walls, in accordance with an embodiment of the present disclosure. FIG. 7 is a printed circuit board (PCB) level chamber isolation vias 700, in accordance with an embodiment of the present disclosure. FIG. 8 is a cutaway of PCB 800 showing continued chamber isolation, in accordance with an embodiment of the present disclosure. For the sake of brevity, FIGS. 6A-6D, 7, and 8 have been explained together. In an embodiment, as illustrated in FIGS. 6A-6D, various supplemental views 600A, 600B, 600C, and 600D of the interlocking gaussian chamber walls are shown where the bottom gaussian chamber wall 104 (i.e., receptacle) may be soldered/welded to the PCB 108 and may remain stationary. Further, the top gaussian chamber wall 102 (i.e., plug) may be soldered to the wire. Thus, as the two slide together and interlock the faces of the two walls touching each other seals against the matching face of the corresponding wall on the opposite side, thereby providing a complete isolation of the signal. Such PCB 108 is shown in FIG. 7 illustrating the PCB level chamber isolation vias 700 that may be used to extend the ground channel into the PCB 108 to maintain good signal integrity.

In an embodiment, as illustrated in FIG. 8, a cutaway of the PCB 800 is shown to highlight continued chamber isolation. The cutaway shows a multi-layer PCB board with multi-level copper traces with vias to allow for top and bottom copper layers to create a waveguide inside the PCB 108. Such vias 700 may be used to connect the top and bottom layers of copper in the PCB 108 and prevent the signal from leaking across the layer inside the board. As illustrated, the cutaway of the PCB 800 may be made of several conductive copper layers 802, and several PCB dielectric layers. Further, a PCB trace 804 may be a conductive path that the signal will follow which may start at the contact pad on the top layer of the PCB 108 where the receptacle feet may attach and may work down and across the PCB 108 using the vias 700 and the PCB trace 804. Furthermore, solid copper layers 806 may form the top and bottom surfaces of the gaussian chamber 102 inside of the layers of the PCB 108. Additionally, the vertical conductive tubes (VIAS) 808 may be embedded in the PCB 108 to connect the horizontal copper layers with a vertical metal surface to contain the electrical field energy of the differential pair. It may be apparent to a person skilled in the art that due to manufacturing limitations, it is not possible to put a vertical solid copper wall in the PCB 108 thus via fence approach is the next best thing and the spacing of the vias is tuned to match the frequencies passing through the gaussian chamber 102. Thus, with the appropriate spacing between the vias the gaussian chamber 102 may be maintained to keep all the signals inside isolated from those on the outside.

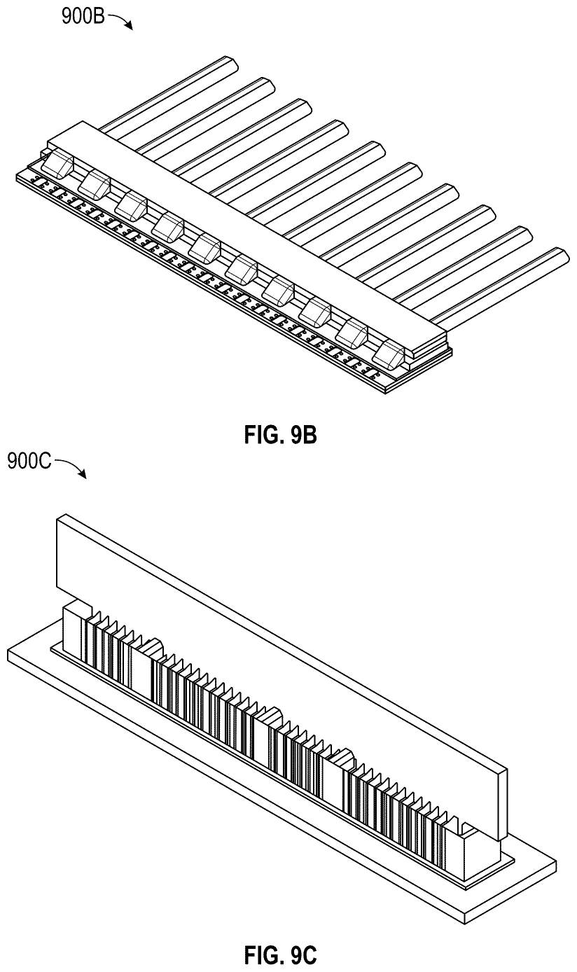

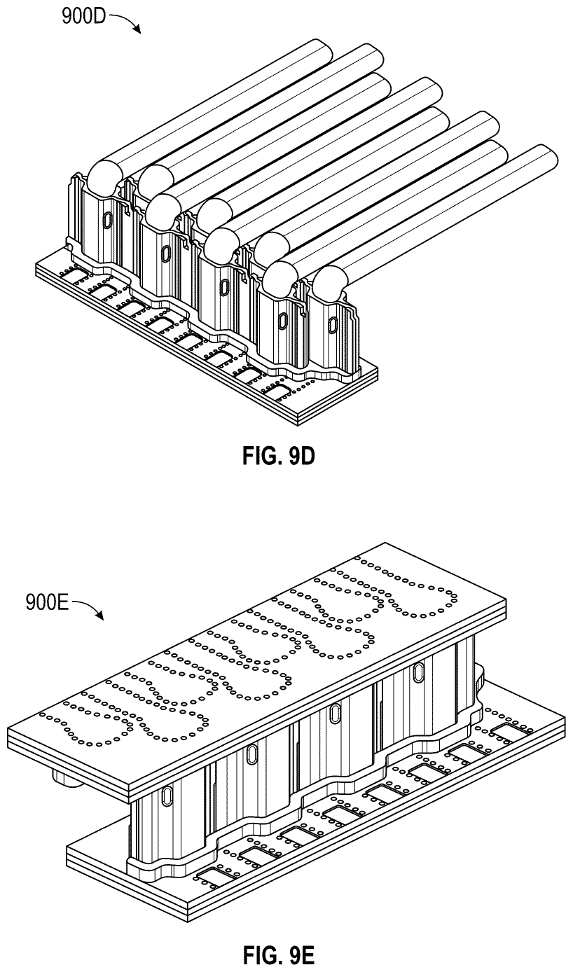

FIGS. 9A-9E are various connector system designs, in accordance with an embodiment of the present disclosure. In an embodiment, each connector style may serve a different purpose because they change the plug and wire orientation to meet the space requirements and needs of the user, for example, some designs like the card edge connector apply the gaussian chamber connector to an existing industry standard to improve performance while maintaining backward compatibility. In an embodiment, as illustrated in FIG. 9A, a vertical system connector 900A is shown with 2 rows by 4 chambers variant that may be configurable with as many rows and chambers as required by the application. In an embodiment, as illustrated in FIG. 9B, a ziff style connector 900B is shown with 1 row by 10 chamber variant that may be configurable with as many rows and chambers as required by the application. In an embodiment, as illustrated in FIG. 9C, a card edge style connector 900C that may be configured to meet any pin count and spacing as required. In an embodiment, as illustrated in FIG. 9D, a right-angle style connector 900D is shown with 2 rows by 4 chamber variant that may be configurable with as many rows and chambers as required by the application. In an embodiment, as illustrated in FIG. 9E, a Board-to-Board style connector 900E is shown with 2 rows by 4 chamber variant that may be configurable with as many rows and chambers as required by the application. It should be noted that this configurations can be customized from a single chamber to multiple chambers and stacked in multiple layers as needed for the application.

Thus, the present disclosure discloses a connection system with a gaussian chamber 102 made of 3 components, namely the plug which terminates the wire, the receptacle which is soldered to the board, and the board or Printed Circuit Board (PCB). The connection system allows isolating each signal inside a gaussian chamber and prevents adjacent chambers from leaking/talking to each other maintaining signal integrity and allowing for data to be transmitted faster and without breaking down. Typically, the gaussian chamber may be one piece to get the best performance but in practice, such arrangements are more difficult because the gaussian chamber needs to separate so that the connector can be unplugged for assembly and while routing the cable through the end product. Thus, the connection system of the present disclosure with 2-piece interlocking gaussian chamber walls allows such access while maintaining a good seal once the plug is seated in the receptacle. The grooves in the connection system still allow the 2 sides to overlap while the flat surface adjacent to the groove provides lots of surface area to create a good seal. Further, the conductive gasket or embossed feature at the junction between the PCB and receptacle helps seal any gaps between the top of the PCB and the bottom of the connector preventing leakage to adjacent chambers while also providing a solid base with a good mechanical connection to the PCB to help keep the receptacle in place as the plug get inserted and removed from the receptacle. It should be noted that the 3D gaussian isolation system can be manufactured as a singled casted metal part or separate walls.

Thus, the present solution overcomes the existing solutions that use a 2-dimensional grounding strategy to prevent adjacent differential pairs from talking to each other by placing a copper ground between the differential pairs to draw that electric field away from adjacent differential pairs and into the ground. Since, in the existing solutions, as signal speed increases the electric field grows stronger and the 2-dimensional grounding strategy struggles to capture all that energy and prevent adjacent pairs from talking to each other causing the signal to break down and performance to be reduced. The connection system of the present disclosure allows 3-dimensional grounding strategy that fully surrounds each differential pair with a copper barrier that creates a much stronger ground signal, capturing significantly more of the electric field energy which in turn reduces how much the adjacent differential pairs can talk to each other.

In an embodiment, the gaussian chamber is continued into the PCB, ensuring that no signal loss occurs. Further, the gaussian chamber prevents adjacent differential pairs from talking to each other (crosstalk), which would otherwise cause the signal to break down. The crosstalk prevention is achieved by continuing the gaussian chamber into the PCB which is made of multiple layers of copper, separated by common dielectric PCB material. Such multi-layer board strategy allows creation of the top and bottom of the gaussian chamber with the copper layers that are connected by Vias in the PCB. Such vias are copper tubes embedded in the dielectric layers of the PCB that may connect the copper layers to each other. Spacing between the vias may be tuned to match the frequencies of the connector. Further, the vias may act as a solid wall of copper and prevent adjacent differential pairs from talking to each other.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. I claim all of the above subject matter.
